(19) United States
(12) Patent Application Publication
(10) Pub. No.: US 2024/0426987 A1
(43) Pub. Date: Dec. 26, 2024

(54) METHOD FOR CALIBRATION OF MULTIPLE LIDARS, AND COMPUTER PROGRAM RECORDED ON RECORD-MEDIUM FOR EXECUTING METHOD THEREFOR

(71) Applicant: MOBILTECH, Seoul (KR)

(72) Inventors: Jae Seung KIM, Seoul (KR); Ah Young YOON, Seoul (KR); Young Jin CHO, Bucheon-si (KR); Se Ram KO, Seongnam-si (KR)

(21) Appl. No.: 18/619,510

(22) Filed: Mar. 28, 2024

(30) Foreign Application Priority Data
Jun. 20, 2023 (KR) 10-2023-0078769

(51) Int. Cl. G01S 7/497

(52) U.S. Cl. CPC G01S 7/497

(57) ABSTRACT

A calibration method for multiple LIDARS may comprise the steps of acquiring, by a data creation device, first point cloud data from a first LIDAR in order to create a reference map, a plurality of second point cloud data acquired from a plurality of second LIDARs mounted on a vehicle traveling on a path on the reference map and specification values for the first LIDAR and the plurality of second LIDARs; performing, by the data creation device, preprocessing on the first point cloud data and the plurality of second point cloud data; and performing, by the data creation device, calibration on the preprocessed first point cloud data and plurality of second point cloud data.

### CROSS-REFERENCE TO RELATED APPLICATIONS

This application claims the priority of Korean Patent Application No. 10-2023-0078769 filed on Jun. 20, 2023, in the Korean Intellectual Property Office, the disclosure of which is incorporated herein by reference.

### TECHNICAL FIELD

The present invention relates to calibration. More specifically, a method for calibrating multiple LIDARs in which a calibration is performed between a LIDAR for creating a reference map and a plurality of LIDARs mounted on a vehicle traveling on a path on the reference map and a computer program recorded on a recording medium for executing the method.

### BACKGROUND ART

Autonomous driving of a vehicle refers to a system that allows the vehicle to drive by making its own decision. This autonomous driving can be divided into progressive stages from non-automation to full automation, depending on the degree to which the system participates in driving and the degree to which a driver controls the vehicle. In general, the stages of autonomous driving are divided into six levels classified by Society of Automotive Engineers (SAE) International. According to the six-stage levels classified by the SAE, level 0 is non-automation stage, level 1 is driver assistance stage, level 2 is partial automation stage, level 3 is conditional automation stage, level 4 is high automation stage, and level 5 is the complete automation stage.

The autonomous driving is performed through the mechanism of perception, localization, path planning and control. And, various companies are developing to implement recognition and path planning in autonomous driving mechanisms using artificial intelligence (AI).

For this autonomous driving, various information about the roads must be collected preemptively. However, in reality, it is not easy to collect and analyze vast amounts of information in real time using only the vehicle's sensors. Accordingly, in order for autonomous driving to become a reality, a high-definition road map that can provide various information necessary for actual autonomous driving is essential.

Here, a high-definition road map refers to a three-dimensional electronic map constructed with information on roads and surrounding terrain with an accuracy of ±25 cm. This high-definition road map includes high-definition information such as road width, road curvature, road slope, lane information (dotted lines, solid lines, stop lines, etc.), surface type information (crosswalks, speed bumps, shoulders, etc.), road mark information, sign information, and facility information (traffic lights, curbs, manholes, etc.), in addition to general electronic map information (node information and link information required for path guidance).

In order to create such high-definition road map, various related data such as mobile mapping system (MMS) and aerial photography information are required.

In particular, the MMS is mounted on a vehicle and is configured to measure the location of landmarks around the road and acquire visual information while driving the vehicle. That is, the MMS may be created based on information collected by a global positioning system (GPS) for acquiring the position and posture information of vehicle body, an inertial navigation system (INS), inertial measurement unit (IMU), a camera to collect the shape and information of terrain features, a light detection and ranging (LIDAR) and other sensors.

However, various sensors for acquiring, photographing, or measuring data as described above cannot be installed at the physically same one point, and because they operate on the basis of the time information of each of sensors, there was a problem with out of sync between sensors.

Meanwhile, the simultaneous localization and mapping (SLAM) system can estimate pose based on information collected by the GPS, inertial navigation device, inertial measurement device, camera, LIDAR and other sensor and at the same time, construct a 3D map.

However, the conventional SLAM system has a problem in that the amount of computation is large due to complex calculations, which requires a lot of work time for localization and mapping.

The present invention is a technology developed with the support of the Ministry of Trade, Industry and Energy/Korea Evaluation Institute of Industrial Technology (Task No.—20022003/Project Name—Automotive Industry Technology Development Project/Task Name—Development of industrial autonomous driving and stability security technology based on vertical and horizontal linkage)

### PRIOR ART LITERATURE

Korean Patent Laid-Open Publication No. 10-2022-0085186, ‘LIDAR sensor calibration method using high-definition map’ (published on Jun. 22, 2022)

### SUMMARY OF THE INVENTION

One purpose of the present invention is to provide a calibration method of a plurality of LIDARs for performing calibration between a LIDAR for creating a reference map and a plurality of LIDARs mounted on a vehicle traveling on a path on the reference map.

Another object of the present invention is to provide a computer program recorded in a recording medium for executing a calibration method of a plurality of LIDARs for performing calibration between a LIDAR for creating a reference map and a plurality of LIDARs mounted on a vehicle traveling on a path on the reference map.

The technical tasks of the present invention are not limited to those mentioned above, and other technical tasks not mentioned will be clearly understood by those skilled in the art from the description below.

In order to achieve the technical tasks described above, the present invention proposes a calibrating method of a plurality of LIDARs. The method may comprise the steps of acquiring, by a data creation device, first point cloud data from a first LIDAR in order to create a reference map, a plurality of second point cloud data acquired from a plurality of second LIDARs mounted on a vehicle traveling on a path on the reference map and specification values for the first LIDAR and the plurality of second LIDARs; performing, by the data creation device, preprocessing on the first point cloud data and the plurality of second point cloud data; and performing, by the data creation device, calibration on the preprocessed first point cloud data and plurality of second point cloud data.

The step of performing the preprocessing may include voxelizing the first point cloud data and the plurality of second point cloud data.

The step of performing the preprocessing may include performing preprocessing by defining outliers on the basis of the distance between points in the first point cloud data and the plurality of second point cloud data.

The step of performing the preprocessing may include detecting the ground from the plurality of second point cloud data, and identifying and removing an object having a height of a preset value on the basis of the detected ground as a noise object.

The step of performing the preprocessing includes detecting the ground from the plurality of second point cloud data, approximating the point cloud detected as the ground to a plane, and then interpolating additional points between the point clouds detected as the ground.

The step of performing the calibration may include performing a normal distribution transform (NDT) matching on each of the first point cloud data and the plurality of second point cloud data, wherein the calibration is performed simultaneously on the plurality of second LIDARs through multi-threading.

The step of performing the calibration may include performing the calibration by designating the specification value of the first LIDAR and each of the plurality of second LIDARs as initial pose.

The step of performing the calibration may include determining a matching between the first point cloud data and the plurality of second point cloud data using a fitness score that is a sum of average and covariance between voxels during the NDT matching process.

The step of performing the calibration may include verifying the calibration by extracting the pose at the point of time when the fitness score is minimum and comparing the fitness score at the point of time when the NDT matching is completed with a preset value.

The step of performing the calibration may include performing a NDT matching with the first point cloud data by designating a region of interest (ROI) to each of the plurality of second point cloud data.

The step of performing the calibration may include designating the region of interest to each of the plurality of second point cloud data on the basis of the coordinate system of the first point cloud data, wherein the region of interest is designated after aligning the coordinate system of the first point cloud data and the plurality of second LIDARs using specification value of each of the plurality of second LIDARs.

The step of performing the calibration may include extracting a pose at point of time when the fitness score is minimum while changing the yaw value of each of the plurality of second point cloud data to a preset angle, and re-inputting the extracted pose as the initial pose of NDT matching. In order to achieve the technical tasks described above, the present invention proposes a computer program recorded on a recording medium for executing the above method. The computer program is combined with a computing device including a memory, a transceiver and a processor for processing instructions loaded in the memory and causes the processor to execute the steps of acquiring first point cloud data from a first LIDAR in order to create a reference map, a plurality of second point cloud data acquired from a plurality of second LIDARs mounted on a vehicle traveling on a path on the reference map and specification values for the first LIDAR and the plurality of second LIDARs; performing, preprocessing on the first point cloud data and the plurality of second point cloud data; and performing calibration on the preprocessed first point cloud data and plurality of second point cloud data.

Specific details of other embodiments are included in the detailed description and drawings.

According to embodiments of the present invention, automatic calibration between a LIDAR for creating a reference map and a plurality of LIDARs mounted on a vehicle traveling on a path on the reference map can be implemented with high accuracy.

The effects of the present invention are not limited to the effect mentioned above, and other effects not mentioned can be clearly understood by those skilled in the art from the description of the claims.

### BRIEF DESCRIPTION OF THE DRAWINGS

FIG. 1 is a configuration diagram of a data creation system according to an embodiment of the present invention.

FIG. 2 is a logical configuration diagram of a data creation device according to an embodiment of the present invention.

FIG. 3 is a hardware configuration diagram of a data creation device according to an embodiment of the present invention.

FIG. 4 is a flow chart for explaining the calibration method of a camera and a LIDAR according to an embodiment of the present invention.

FIG. 5 is a flowchart for explaining a calibration method of a LIDAR and an inertial measurement device according to an embodiment of the present invention.

FIG. 6 is a flowchart for explaining a calibration method of a plurality of LIDARs according to an embodiment of the present invention.

FIG. 7 is a flow chart for explaining a visual mapping method according to an embodiment of the present invention.

FIGS. 8 to 11 are exemplary diagrams for explaining a calibration method of a camera and a LIDAR according to an embodiment of the present invention.

FIGS. 12 and 13 are exemplary diagrams for explaining a calibration method of a LIDAR and inertial measurement device according to an embodiment of the present invention.

FIGS. 14 and 15 are exemplary diagrams for explaining a calibration method of a plurality of LIDARs according to an embodiment of the present invention.

FIGS. 16 and 17 are exemplary diagrams for explaining a visual mapping method according to an embodiment of the present invention.

### DETAILED DESCRIPTION OF THE INVENTION

It should be noted that the technical terms used in this specification are only used to describe specific embodiments and are not intended to limit the present invention. Also, the technical terms used in this specification, unless specifically defined in a different way in this specification, should be interpreted as meanings generally understood by those skilled in the art to which the present invention pertains, and should not be interpreted in excessively comprehensive or excessively reduced sense. Also, if the technical terms used in this specification are incorrect technical terms that do not accurately express the idea of the present invention, they should be replaced with technical terms that can be correctly understood by a person skilled in the art. Also, general terms used in the present invention should be interpreted according to the definition in the dictionary or according to the context, and should not be interpreted in an excessively reduced sense.

Also, as used herein, singular expressions include plural expressions, unless the context clearly dictates otherwise. In the present application, it should not be construed that terms such as “configured” or “have” necessarily include all of various components or steps described in the specification. Some of the components or steps cannot be included, or it can include additional components or steps.

Also, terms including ordinal numbers such as first, second, etc., used in this specification can be used to describe various components, but these components should not be limited by the above terms. The above terms are used only for the purpose of distinguishing one component from another. For example, a first component can be named a second component, and similarly, the second component can also be named a first component without departing from the scope of the present invention.

When a component is said to be “coupled” or “connected” to another component, it can be directly coupled to or connected to other components, but there can also be other components therebetween. In contrast, when a component is said to be “directly coupled or “directly connected” to another component, it should be understood that there are no other components therebetween.

Hereinafter, preferred embodiments according to the present invention will be described in detail with reference to the attached drawings, but identical or similar components will be assigned the same reference numbers regardless of the drawing numerals, and duplicate descriptions thereof will be omitted. Also, when describing the present invention, if it is determined that a detailed description of related well-known technologies can obscure the gist of the present invention, the detailed description thereof will be omitted. Also, it should be noted that the attached drawings illustrate the present invention only for making the spirit of the present invention easily understandable and should not be construed as limiting the spirit of the present invention by the attached drawings. The spirit of the present invention should be construed as encompassing all changes, equivalents, or substitutions other than the attached drawings.

Meanwhile, MMS is mounted on a vehicle and measures the location of landmarks around the road and acquires visual information while driving the vehicle. In other words, the MMS can be created based on information which have been collected by a global positioning system (GPS) for acquiring the position and posture information of the vehicle body, an inertial navigation system (INS), an inertial measurement unit (IMU), a camera for collecting the shape and information of terrain features, a light detection and ranging (LIDAR) and other sensors.

However, various sensors for acquiring, photographing, or measuring data as described above cannot be installed at the physically same one point, and because they operate on the basis of the time information of each of sensors, there was a problem with out of sync between sensors.

Meanwhile, the simultaneous localization and mapping (SLAM) system can estimate pose based on information collected by the GPS, inertial navigation device, inertial measurement device, camera, LIDAR and other sensor and at the same time, construct a 3D map.

However, the conventional SLAM system has a problem in that the amount of computation is large due to complex calculations, which requires a lot of work time for localization and mapping.

To overcome this problem, the present invention seeks to propose various means that can perform calibration between a plurality of sensors and create an accurate feature map.

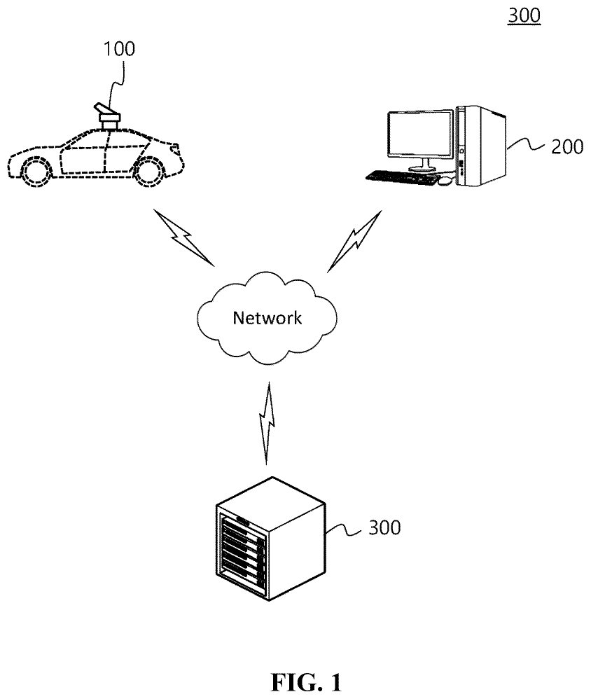

FIG. 1 is a configuration diagram of a data creation system according to an embodiment of the present invention.

Referring to FIG. 1, the data creation system 300 according to an embodiment of the present invention can be configured to include a data collection device 100, a data creation device 200, and a data processing device 300.

The components of the data creation system according to this embodiment are merely functionally distinct, and in an actual physical environment, two or more components can be integrated with each other or separated from each other.

Explaining respective components, the data collection device 100 can be mounted on a vehicle and collect data necessary for creating a map and learning data.

The data collection device 100 can be configured to include one or more of LIDAR, camera, radar, inertial measurement unit (IMU) and global positioning system (GPS), but is not limited thereto. The data collection device 100 can be equipped with sensors capable of sensing various information to create an accurate road map.

That is, the data collection device 100 can acquire point cloud data from the LIDAR and can acquire images captured from a camera. Also, the data collection device 100 can acquire information related to location and pose from the IMU, GPS, etc.

Here, the LIDAR can fire laser pulses around the vehicle and detect the light reflected by objects located around the vehicle, creation point cloud data corresponding to a 3D image around the vehicle.

The camera can acquire images of the space collected from LIDAR with the LIDAR as the center. These cameras can include any one of a color camera, a near infrared (NIR) camera, a short wavelength infrared (SWIR) camera, and a long wavelength infrared (LWIR) camera.

The inertial measurement device consists of an acceleration sensor and an angular velocity sensor (gyroscope), and some thereof can further include a geomagnetic sensor (magnetometer) and detect changes in acceleration according to changes in the movement of the data collection device 100.

The GPS can receive signals transmitted from satellites and measure the location of the data collection device 100 using triangulation.

This data collection device 100 can be installed in a vehicle or aerial device.

For example, the data collection device 100 can be installed on the top of a vehicle to collect surrounding point cloud data or images, or installed at the bottom of an aerial device to collect point cloud data or images for objects on the ground from the air.

Also, the data collection device 100 can transmit the collected point cloud data or image to the data creation device 200.

The data creation device 200 can receive point cloud data acquired by LIDAR and images captured by a camera from the data collection device 100.

The data creation device 200 can create an accurate high-definition road map using the received point cloud data and a camera, and can create learning data using the high-definition road map.

Characteristically, according to an embodiment of the present invention, the data creation device 200 extracts respective one frame for the image captured by a camera and the point cloud data acquired by LIDAR, and identify feature points on the calibration board included in one frame for each of the image and LIDAR. Also, the data creation device 200 can perform calibration of the camera and LIDAR based on the identified feature points.

According to another embodiment of the present invention, the data creation device 200 arranges point cloud data acquired from a LIDAR mounted on a vehicle on a predefined world coordinate system, and extract a region to be used for calibration among the arranged point cloud data. Also, the data creation device 200 can perform calibration on the point cloud data by identifying at least one object included in the extracted region and fitting the point cloud included in at least one identified object to a pre-stored model.

According to another embodiment of the present invention, the data creation device 200 can acquire first point cloud data from a first LIDAR in order to create a reference map, a plurality of second point cloud data acquired from a plurality of second LIDARs mounted on a vehicle traveling on a path on the reference map and specification values for the first LIDAR and the plurality of second LIDARs and can perform preprocessing on the first point cloud data and the plurality of second point cloud data. Also, the data creation device 200 can perform calibration on the preprocessed first point cloud data and plurality of second point cloud data.

According to another embodiment of the present invention, the data creation device 200 can create a first feature map based on point cloud data acquired from LIDAR and images captured from a camera, and create a third feature map by mapping the first feature map to the second feature map created using the pre-stored point cloud data.

Meanwhile, the various embodiments of the present invention are described as performing separate functions, but the present invention is not limited to this and can be applied in combination with each other's functions.

Any device that can transmit and receive data with the data collection device 100 and the data processing device 300 and perform calculations based on the transmitted and received data is acceptable as the data creation device 200 which has the above characteristics. For example, sync device 300 can be any one of stationary computing devices such as a desktop, workstation, or server, but is not limited thereto.

The data processing device 300 can process the map created by the data creation device 200.

For example, the data processing device 300 can correct facility information on a map created by the data creation device 200 or remove noise from the created map. Also, the data processing device 300 can detect a specific object in the created map or perform weight reduction on the data.

The data processing device 300, which has these characteristics, is can be any device that can transmit and receive data with the data collection device 100 and the data creation device 200 and perform calculations based on the transmitted and received data is acceptable as the data processing device 300 which has the above characteristics. For example, the sync device 300 can be any one of stationary computing devices such as a desktop, workstation, or server, but is not limited thereto.

As described above, the data collection device 100, the data creation device 200 and the data processing device 300 can transmit and receive data using a network which has a combination of one or more of a security line that directly connects the devices, a public wired communication network or a mobile communication network.

For example, public wired communication network can include an Ethernet, a x digital subscriber line (xDSL), a hybrid fiber coax (HFC), and a fiber to the home (FTTH), but is not limited thereto. Also, the mobile communication network can include a code division multiple access (CDMA), a wideband CDMA (WCDMA), a high speed packet access (HSPA), a long term evolution (LTE) and the 5th creation mobile telecommunication, but is not limited thereto.

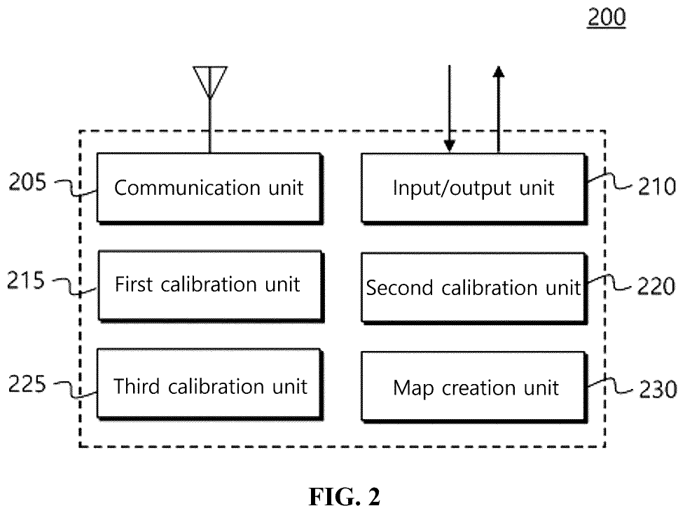

FIG. 2 is a logical configuration diagram of a data creation device according to an embodiment of the present invention.

Referring to FIG. 2, the data creation device 200 according to an embodiment of the present invention can be configured to include a communication unit 205, an input/output unit 210, a first calibration unit 215, a second calibration unit 220, a third calibration unit 225 and a map creation unit 230.

Since such components of the data creation device 200 merely represent functionally distinct elements, two or more components can be integrated with each other in the actual physical environment, or respective components can be separated from each other in the actual physical environment.

Explaining regarding respective components, the communication unit 205 can transmit and receive data to/from the data collection device 100 and the data processing device 300. Specifically, the communication unit 205 can receive point cloud data acquired by LIDAR from the data collection device 100 and images captured by the camera.

The input/output unit 210 can receive a signal from a user through a user interface (UI) or output the calculated result to the outside. Specifically, the input/output unit 210 can receive setting information for calibration between sensors. Also, the input/output unit 210 can output the calibration result and the created map.

The first calibration unit 215 can perform calibration between the camera and the LIDAR.

Specifically, the first calibration unit 215 can extract one frame for each of the image captured by the camera and the point cloud data acquired by the LIDAR. Each frame for extracted image and for the LIDAR can include a calibration board.

Next, the first calibration unit 215 can identify the feature point of the calibration board included in one frame for each of the extracted image and the LIDAR.

Here, the calibration board is a rectangular checker board, and on the edge of which an edge identification region made of a material with an intensity higher than the preset value and a top point identification region located at the top of the edge identification region and made of a material with an intensity lower than the preset value can be formed.

For example, the calibration board can have the edge identification region formed by attaching a high-brightness tape made of a material with an intensity higher than a preset value along the edge of the checker board. The top point identification region can be formed by removing a portion of the high-brightness tape located at the top of the calibration board.

Specifically, the first calibration unit 215 can identify a corner based on the size and number of calibration board in the image captured by the camera. For example, the first calibration unit 215 can extract the calibration board on the image based on a source checkerboard image corresponding to the calibration board, the number of internal corner per the row and column of the checkerboard and the output arrangement of the detected corner, and identify the corner of the extracted calibration board.

At this time, the first calibration unit 215 can assign an index by identifying a point corresponding to the corner using a pattern preset on the basis of the feature point located at the top or bottom of the calibration board.

For example, the first calibration unit 215 can assign the index in a way that the numbers increase downward to the right on the basis of the feature point located at the top of the calibration board or in a way that the numbers increase upward to the left on the basis of the feature point located at the bottom of the calibration board.

Also, the first calibration unit 215 can detect the calibration board in the point cloud data on the basis of the edge identification region with relatively high intensity on the calibration board, and identify the feature point within the detected calibration board.

Specifically, the first calibration unit 215 can create a virtual plane on the basis of the point cloud included in the edge identification region and connect the outermost points for each channel in the created virtual plane to thereby form a plurality of straight lines. Also, the first calibration unit 215 can detect the vertex of the calibration board on the basis of the intersection point of the plurality of created straight lines and identify the feature point of the calibration board on the basis of the detected vertex.

That is, the first calibration unit 215 can identify four vertices included in the calibration board and identify feature point of the calibration board based on the pre-stored size and number of the calibration board. Here, the feature point of the calibration board identified in the point cloud data can correspond to the feature point identified in the image.

Here, the first calibration unit 215 can match the index of the feature point identified from the previously identified image with the feature point identified from the LIDAR based on the top point identification region of the calibration board.

And, the first calibration unit 215 can perform calibration of the camera and LIDAR based on the feature points identified from each of the image and point cloud data.

Specifically, the first calibration unit 215 can calculate external parameters including a rotation value and a translation value based on the feature points of the calibration board included in each of the image and point cloud data, and perform calibration on the basis of the calculated external parameters.

At this time, the first calibration unit 215 can separately calculate the rotation value and the translation value. Preferably, the first calibration unit 215 can calculate the translation value after calculating the rotation value.

First, when the rotation value is defined as a rotation value from the first viewpoint to the second viewpoint, it can be calculated through the following equation.

$$\vert ( {f}_{1} * {Rf}_{1}^{′} ) ( {f}_{2} * {Rf}^{′} 2 ) ( {f}_{3} * {Rf}_{3}^{′} ) \vert = 0 \qquad [ Equation ]$$

wherein, R is the rotation value, and f, f′ are rays from the first and second view points to the feature point of the calibration board included in the point cloud data.

The translation value can be calculated through a loss function based on a RE-Projection Error (RPE). Here, the RPE may refer to the degree to which a point observed in an image is distorted by being projected onto the image.

The second calibration unit 220 can perform calibration of the LIDAR and the inertial measurement device using features according to the shape of a specific object included in the point cloud data acquired from the LIDAR.

Specifically, the second calibration unit 220 can arrange the point cloud data acquired from a LIDAR mounted on a vehicle in a predefined world coordinate system.

At this time, the second calibration unit 220 can define the world coordinate system through position information measured from at least one of a global positioning system (GPS) and an inertial measurement unit (IMU) acquired simultaneously with point cloud data.

Next, the second calibration unit 220 can extract a region to be used in the calibration among the arranged point cloud data.

Specifically, the second calibration unit 220 can extract a trajectory in which the heading standard deviation, which indicates the error in GPS data in the travel path of the vehicle equipped with the LIDAR, is lower than a preset value, and extract a section that simultaneously includes trajectories having the direction of travel of the vehicle which are opposite to each other within the extracted trajectory.

Generally, the GPS data is data that have been post-processed using several data such as GPS information, inertial measurement unit (IMU) information, distance measurement instrument (DMI) information and base station information. Even after the GPS data is post-processed using other data, there are cases where errors occur due to the influence of objects such as tall buildings made of highly reflective materials.

Meanwhile, the calibration can only increase the accuracy, if it is performed at a location where the error in the GPS data is lowest. Accordingly, the second calibration unit 220 can extract the most appropriate path that can be used for calibration in the entire section.

Meanwhile, Table 1 below shows the structure of the GPS data.

TABLE 1

| Variables | Contents | Unit |
|---|---|---|
| Time | Time | Sec |
| Easting | IMU World x | m |
| Northing | IMU World y | m |
| Up | IMU World z | m |
| Roll | IMU roll | degree |
| Pitch | IMU pitch | degree |
| Heading | True north direction | degree |
| EastVel | World x velocity | m/s |
| NorthVel | World y velocity | m/s |
| UpVel | World z velocity | m/s |
| EastSD | World x standard deviation | m |
| NorthSD | World y standard deviation | m |
| UpSD | World z standard deviation | m |
| RollSD | IMU roll standard deviation | degree |
| PitchSD IMU | IMU pitch standard deviation | degree |
| HeadingSD | IMU north standard deviation | degree |
| xAngVel | Roll velocity | degree/s |
| yAngVel | Pitch velocity | degree/s |
| zAngVel | Heading velocity | degree/s |

Referring to Table 1, if the heading value indicating true north is distorted, the point cloud shape of the object to be used for calibration will collapse. Accordingly, the second calibration unit 220 can extract a trajectory whose heading standard deviation is lower than a preset value.

Also, if calibration is performed on a section where the vehicle has travelled in one direction among trajectories where the heading standard deviation is lower than the preset value, the created map can be distorted because the slope is not taken into account. Accordingly, the second calibration unit 220 can extract a section that simultaneously includes trajectories having the direction of travel of the vehicle which are opposite to each other within the extracted trajectory

For example, the second calibration unit 220 can create the heading standard deviation as a 10-quantile, extract the trajectories of the lower 10% of the heading standard deviation, and check whether two or more separated trajectories come within the window while operating a sliding window of a certain size. At this time, if two or more trajectories exist in the window, the average heading value of each trajectory is calculated to determine whether trajectories with opposite directions exist, and if so, the corresponding section can be determined as an appropriate trajectory for calibration.

Next, the second calibration unit 220 can identify at least one object included in the extracted region.

Meanwhile, a sphere shape that can take all x-axis, y-axis and z-axis into consideration can be said to be the most suitable object to be used for calibration. In other words, the spherical shape can identify distortion in any direction. However, in reality, there exist relatively few spherical objects.

Alternatively, when performing calibration on the basis of a wall, it is possible to calibrate in a direction perpendicular to the wall, but it is difficult to calibrate in a direction horizontal to the wall. Therefore, calibration in the horizontal direction can be performed only by using two or more walls parallel to each other.

Accordingly, the second calibration unit 220 exists in relatively large numbers in reality, and a cylindrical object capable of horizontal fitting is used for calibration. That is, the second calibration unit 220 can identify a cylindrical object for horizontal fitting among the arranged point cloud data. For example, cylindrical objects can include streetlights, electric poles, traffic lights, etc.

Also, the second calibration unit 220 can identify a ground for vertical fitting among the arranged point cloud data. At this time, the second calibration unit 220 can extract a region of a preset size on the basis of the midpoint of the extracted section and recognize it as the ground. That is, the second calibration unit 220 can extract a region of a preset size as the ground on the basis of the x-axis and y-axis from the midpoint of the extracted trajectory, under the assumption that the vehicle equipped with the data collection device 100 is running on the road.

Next, the second calibration unit 220 can perform calibration of the point cloud data by fitting the point cloud included in the at least one identified object to a pre-stored model.

Specifically, the second calibration unit 220 can calculate the value, which has been obtained by dividing the number of inlier point clouds fitted to a pre-stored cylinder model corresponding to a cylindrical object by the number of point clouds included in the cylindrical object, as the loss for the cylindrical object.

Also, the second calibration unit 220 can calculate the value, which has been obtained by dividing the number of inlier point clouds fitted to the pre-stored ground model corresponding to the ground by the number of point clouds included in the ground, as the loss for the cylindrical object.

The second calibration unit 220 can perform calibration on the point cloud data using a loss function configured based on the loss for the cylindrical object and the loss for the ground. That is, the second calibration unit 220 can configure a loss function as shown in the code below.

$$double loss = ( - 1 ) * pole\_loss + ( - 1 ) * ground\_loss$$

wherein the pole_loss means loss for the object, and the ground_loss means loss for the ground.

Here, assuming that the number of point clouds for the identified object is n and when applying the RANSAC algorithm using a cylinder model, if the number of inliers in the fitted cylinder model is i, the loss for the object can be calculated using the code below:

pole_loss=i/n

Also, assuming that the number of point clouds for the identified ground is n and when applying the RANSAC algorithm using the ground model, if the number of inliers in the fitted ground model is i, the loss for the ground can be calculated using the code below:

ground_loss=i/n

Meanwhile, compared to vertical fitting that considers only the z-axis, horizontal fitting that considers both the x-axis and y-axis may cause a problem with losses being calculated imbalanced. This imbalance in losses can make it difficult to converge to the correct answer because in the calibration process, a search is conducted near the local minimum rather than adjusting the ground first and moving to another location at the state that the loss has already dropped.

Accordingly, the second calibration unit 220 can add a loss corresponding to the ratio between the loss for the cylindrical object and the loss for the ground to the loss function.

Meanwhile, the loss for the ratio between the loss for the cylindrical object and the loss for the ground can be calculated through the code below:

double ratio_loss;
if(pole_loss > ground_loss)
ratio_loss = ground_loss / pole_loss;
else // pole_loss < ground_loss
ratio_loss = pole_loss / ground_loss;

Finally, the second calibration unit 220 can configure the loss function as shown in the code below:

$$double lambda = 0.5 ;$$

$$double loss = ( - 1 ) * pole\_loss + ( - 1 ) * ground\_loss + ( - 1 ) * ratio\_loss * lambda ;$$

Here, λ of 0.5 can solve the problem that the loss no longer goes down when the loss for the object and the loss for the ground are the same value.

And, the second calibration unit 220 can perform calibration on the point cloud data through particle swarm optimization (PSO) using the loss function.

For example, the particle swarm optimization can be configured with the code below:

Algorithm 1: Particle Swarm Optimization

| | Input : Objective function ƒ : X → [symbol] , |
|---|---|
| | Termination condition ψ : X → [symbol] , |
| | Population size: N, |
| | Lower and upper bounds of the solution: b [symbol] _{b} and b_{ub}, |
| | Maximum influence values ϕ₁ and ϕ₂ |
| | Output: Best solution g |
| 1 | // Step 1: Initialization. |
| 2 | Randomly initialize the population [symbol] = {x₁, x₂, ..., x_{N}}. |
| 3 | Randomly initialize the particle's velocity within [b [symbol] _{b}, b_{ub}]. |
| 4 | repeat |
| 5 | \| for i ϵ {1, 2, 3, ..., N} do |
| 6 | \| \| // Step 2: Velocity Calculation. |
| 7 | \| \| // d is a dimensionality of the input space X. |
| 8 | \| \| Generate a random vector r₁ ~ U[0, ϕ₁]^{d} |
| 9 | \| \| Generate a random vector r₂ ~ U[0, ϕ₂]^{d} |
| 10 | \| \| vᵢ^{(k+1)} ← vᵢ^{(k)} + r₁(pᵢ − xᵢ^{(k)}) + r₂(g − xᵢ^{(k)}) |
| 11 | \| \| // Step 3: Position Update |
| 12 | \| \| xᵢ^{(k+1)} ← xᵢ^{(k)} + vᵢ^{(k+1)} |
| 13 | \| \| // Step 4: Evaluation |
| 14 | \| \| if ƒ(xᵢ^{(k+1)}) < ƒ(pᵢ) then |
| 15 | \| \| \| pᵢ ← xᵢ |
| 16 | \| \| \| if ƒ(pᵢ) < ƒ(g) then |
| 17 | \| \| \| \| g ← pᵢ |
| 18 | \| \| \| end |
| 19 | \| \| end |
| 20 | \| end |
| 21 | until ψ(X) == TRUE; |
| 22 | return g |

[symbol]

indicates data missing or illegible when filed

Also, the second calibration unit 220 can configure the loss function in a way of optimizing using the variance of the point cloud of the identified object.

Specifically, the second calibration unit 220 can configure at least one identified object into an octree and perform calibration on point cloud data using the variance summation of each leaf node of the configured octree as the loss.

At this time, the second calibration unit 220 can configure a loss function by adding the length of the z-axis of the point cloud data to the variance summation loss, and perform calibration on the point cloud data based on the loss function. Through this, the second calibration unit 220 can configure a loss function that is continuous for the ground fitting and that the randomness has been removed.

The third calibration unit 225 can perform calibration between a plurality of LIDARs.

First, the third calibration unit 225 can acquire a first point cloud data acquired from a first LIDAR in order to create a reference map, a plurality of second point cloud data acquired from a plurality of second LIDARs mounted on a vehicle traveling on a path on the reference map, and specification values for the plurality of second LIDARs.

For example, the first LIDAR can be a LIDAR for creating a map, and the plurality of second LIDARs can be LIDARs mounted on a vehicle that travels along a path on the map to update the created map. Here, the plurality of second LIDARs can be a LIDAR that acquires point cloud data for the front side of the vehicle, a LIDAR that acquires point cloud data for the rear side of the vehicle and a LIDAR that is installed on the roof of the vehicle to acquire 360-degree point cloud data.

Next, the third calibration unit 225 can perform preprocessing on the first point cloud data and the plurality of second point cloud data.

Specifically, the third calibration unit 225 can voxelize the first point cloud data and the plurality of second point cloud data. Through this, the third calibration unit 225 can reduce the difference in the number of points between the first LIDAR and one of the plurality of second LIDARs and remove the noise.

Also, the third calibration unit 225 can perform preprocessing by defining outliers on the basis of the distance between points in the first point cloud data and the plurality of second point cloud data.

Meanwhile, since calibration is performed between the LIDAR for creating the reference map and the LIDAR mounted on the vehicle, point clouds corresponding to vehicle or people that do not exist on the reference map cause an error in calibration.

Accordingly, the third calibration unit 225 can detect the ground from the plurality of second point cloud data and remove an object having a height of a value preset on the basis of the detected ground. That is, the third calibration unit 225 can perform preprocessing to delete objects such as vehicle and people on the basis of the height from the ground.

Also, the fitness score used in NDT matching, which will be described later, can mean the average of the distances of the points whose distance is less than a certain value after matching each point of one of the plurality of second point cloud data with the closest point in the first point cloud data. Accordingly, in order to reduce the error in the z-axis values of the plurality of second LIDARs, the specific gravity of the ground must be as large as the wall and pillar.

Accordingly, the third calibration unit 225 can detect the ground from a plurality of second point cloud data, approximate the point cloud detected as the ground to a plane, and then interpolate additional point between the point clouds detected as the ground.

Next, the third calibration unit 225 can perform calibration on the preprocessed first point cloud data and the plurality of second point cloud data.

Specifically, the third calibration unit 225 can simultaneously perform calibration on the plurality of second LIDARs through multi-threading.

For the calibration, the third calibration unit 225 can perform a normal distribution transform (NDT) matching for the first point cloud data and each of the plurality of second point cloud data. At this time, the third calibration unit 225 can perform calibration by designating the specification values of the first LIDAR and each of the plurality of second LIDARs as an initial pose.

Here, the NDT matching is an algorithm that calculates a transformation matrix through matching between point cloud data. When the first point cloud data and each of the plurality of second point cloud data overlap, the error of each point can be minimized by calculating with a normal distribution. In other words, the NDT algorithm is an algorithm that matches each of the plurality of second point cloud data on the basis of the first point cloud data, and can divide the first point cloud data into a grid of a certain size, approximate the point clouds in the grid with a normal distribution, and then optimize the rotation value and translation value in a direction that increases the probability that each point of each of the plurality of second point cloud data will be within the grid.

In the process of NDT matching, the third calibration unit 225 can use a fitness score, which is a sum of the errors in the average and covariance between voxels, to determine matching between the first point cloud data and the plurality of second point cloud data. Here, the fitness score may mean the average of the distances of points whose distance is less than a certain value after matching each point of one of the plurality of second point cloud data translated into a pose as a result of NDT matching with the closest point in the first point cloud data. At this time, the third calibration unit 225 can extract the pose at the point of time when the fitness score becomes minimum. The third calibration unit 225 can verify the calibration by comparing the fitness score at the point of time when the NDT matching is completed with a preset value.

Also, the third calibration unit 225 can perform NDT matching with the first point cloud data by designating a region of interest (ROI) to each of the plurality of second point cloud data. At this time, the third calibration unit 225 can designate a region of interest to each of the plurality of second point cloud data on the basis of the coordinate system of the first point cloud data, wherein the region of interest can be designated after aligning the coordinate systems of the first point cloud data and the plurality of second point cloud data using the specification value of each of the plurality of second LIDARs. The third calibration unit 225 can determine the matching between the first point cloud data and the plurality of second point cloud data using the fitness score of the designated region of interest. At this time, the third calibration unit 225 can extract the pose at the point of time when the fitness score becomes minimum. For example, the third calibration unit 225 can select a region where no movement is expected from the operator as the region of interest.

Here, the third calibration unit 225 can extract the pose at the point of time when the fitness score becomes minimum by performing NDT matching while changing the yaw value of each of the plurality of second point cloud data to a preset angle

For example, the third calibration unit 225 can perform the NDT matching by changing the yaw value of one of the plurality of second LIDARs within a range of ±3° by 0.1°, and obtain the minimum fitness score and the pose at the point of time of the corresponding fitness. At this time, the third calibration unit 225 can input the minimum fitness score and the pose at the point of time of the corresponding fitness again as the initial pose for NDT matching, and if the pose converges by repeating NDT matching, adopt the pose at the corresponding point of time as the result.

The map creation unit 230 can create a feature map by mapping the feature point of an image captured by a camera to a point cloud data acquired by the LIDAR.

To this end, the map creation unit 230 can create a first feature map based on the point cloud data acquired by the LIDAR and the image captured by the camera.

Specifically, the map creation unit 230 can acquire the point cloud data and image through a LIDAR mounted on a vehicle and acquiring point cloud data and a camera installed at the same location as the LIDAR.

The map creation unit 230 can extract a feature point from the acquired image and create a first feature map configured with the extracted feature point. Here, the map creation unit 230 can extract the feature point from each pixel included in the image based on the continuity of brightness of pixels that exist within a preset range.

That is, if there are n or more consecutive pixels that are brighter than a certain value or n or more consecutive pixels that are darker than a certain value, compared to the specific pixel included in the image, the map creation unit 230 can determine the specific pixel to be a corner point.

To this end, the map creation unit 230 can determine whether there is a corner point or not using a decision tree. That is, the map creation unit 230 can classify the brightness value of a pixel into three values: a case that it is much darker than a specific pixel and a case that it is similar to the specific pixel, and express the brightness distribution of pixels on the circumference as a ternary vector of sixteen dimensions using the classified values. The map creation unit 230 can classify whether there is a corner point or not by inputting the expressed ternary vector into the decision tree.

Also, the map creation unit 230 can gradually reduce the image to a preset scale and apply a blurring thereto, extract the outline and corner included in the image through the difference of Gaussian (DoG) function, extract pixels of the maximum and minimum values for each pixel in the image composed of the extracted outline and corner and extract pixels having the extracted maximum and minimum values as the feature point.

Also, the map creation unit 230 can set a window centered on each pixel included in the image and detect a corner by moving the set window by a predetermined direction and distance. For example, the map creation unit 230 can calculate the amount of image change when the window is moved by 1 pixel in the four directions vertically, horizontally, left diagonally, and right diagonally for each pixel position, set the minimum value of the amount of image change to the value of image change of the corresponding pixel, and classify the point where the set minimum value is locally maximized as a corner point.

As a result, the map creation unit 230 can create a feature map based on feature point located at the detected corner among feature points extracted based on the continuity of brightness. That is, the map creation unit 230 can create a first feature map composed only of feature point extracted from the image.

Next, the map creation unit 230 may create a third feature map by mapping the first feature map to the second feature map created using pre-stored point cloud data.

Specifically, the map creation unit 230 can map the first feature map to the second feature map based on the location information and pose information of the point cloud data acquired simultaneously with the image for creating the first feature map.

Meanwhile, the second feature map can be a point cloud map created using an equipment, which acquires the image and point cloud data, for creating the first feature map and point cloud data acquired by the same equipment.

Accordingly, the map creation unit 230 can omit the pose optimization process when mapping the first feature map to the second feature map. Due to this, the map creation unit 230 can not only create a lightweight feature map created from only the feature point, but also create a third feature map at high speed.

Also, the map creation unit 230 can receive at least one image for location estimation in real time after creating the third feature map.

The map creation unit 230 can analyze at least one received image in real time to extract the feature point. Here, the map creation unit 230 can extract the feature point from the image in the same manner as the method of extracting feature point to create the first feature map described above.

And, the map creation unit 230 can estimate the location on the image received in real time by matching the extracted feature point with the third feature map. At this time, the map creation unit 230 can estimate the pose of the camera of the data collection device based on information about the feature point of at least one image received in real time and the feature point of the third feature map. For example, the map creation unit 230 can calculate the current location and pose on the image using the pnpsolver function. That is, the map creation unit 230 can estimate the position and pose of the camera that captures the real-time received image based on the feature point of the real-time received image and the feature point on the third feature map.

Also, when the map creation unit 230 fails to estimate the location of a first image among at least one images, the map creation unit 230 can estimate the location of the first image based on the pose of the second image that is an image for which location estimation was previously successful. That is, the map creation unit 230 can predict the location of the image that failed to estimate the location based on the location and pose of the previously captured image.

Meanwhile, at least one images received in real time can be an image captured by a terminal equipped with a camera and an inertial measurement device.

At this time, the map creation unit 230 can estimate the location of the first image by reflecting the pose measured by the inertial measurement device on the basis of the pose of the second image, to thereby increase the accuracy of location and pose estimation of the image for which location estimation was failed.

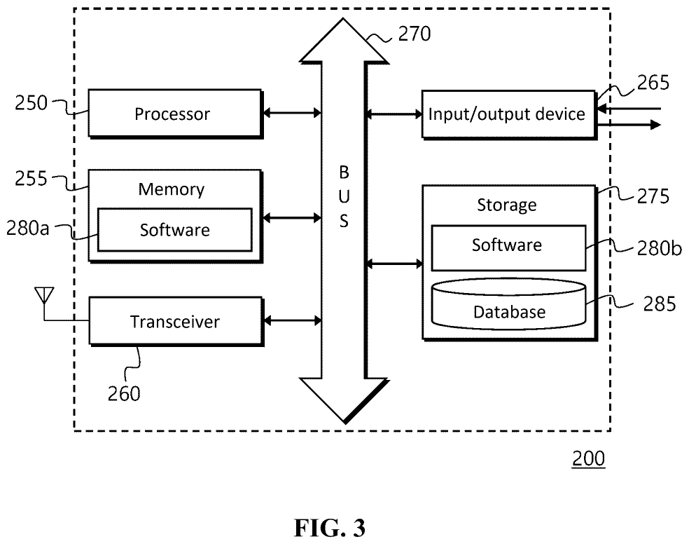

FIG. 3 is a hardware configuration diagram of a data creation device according to an embodiment of the present invention.

Referring to FIG. 3, the data creation device 200 may be configured to include a processor 250, a memory 255, a transceiver 260, an input/output device 265, a data bus 270 and a storage 275.

The processor 250 can implement the operation and function of the data creation device 200 based on instructions according to the software 280a loaded in the memory 255. The software 280a implementing the method according to the present invention can be loaded in the memory 255. The transceiver 260 can transmit and receive data with the data collection device 100 and the data processing device 300.

The input/output device 265 can receive data required for the operation of the data creation device 200 and output the created result value. The data bus 270 is connected to the processor 250, memory 255, transceiver 260, input/output device 265 and storage 275, and can perform the role of a moving path through which respective components can transfer data to each other.

The storage 275 can store an application programming interface required for execution of software 280a in which the method according to the invention has been embodied.

The storage 275 can store an application programming interface (API), library files, resource files, etc. necessary to execute software 280b in which the method according to the present invention is implemented. Also, the storage 275 can store information necessary to perform the calibration method and map creation method. In particular, the storage 275 can include a database 285 that stores programs for performing the calibration method and map creation method.

According to one embodiment of the present invention, the software 280a and 280b loaded in the memory 255 or stored in the storage 275 may be a computer program recorded on a recording medium which causes a processor 250 to execute a step of extracting a calibration board from each of image captured by a camera and the point cloud data acquired by a LIDAR, a step of identifying feature point of the calibration board included in each of the image and point cloud data and a step of performing calibration on the camera and the LIDAR based on the identified feature point.

According to other embodiment of the present invention, the software 280a and 280b loaded in the memory 255 or stored in the storage 275 may be a computer program recorded on a recording medium which causes a processor 250 to execute a step of arranging point cloud data acquired from a LIDAR mounted on the vehicle on a world coordinate system, a step of extracting an region to be used for calibration among the arranged point cloud data, a step of identifying at least one object included in the extracted region and a step of fitting the point cloud data included in the identified at least one object to a pre-stored model to thereby perform calibration on the point cloud data.

According to another embodiment of the present invention, the software 280a and 280b loaded in the memory 255 or stored in the storage 275 may be a computer program recorded on a recording medium which causes a processor 250 to execute a step of acquiring first point cloud data acquired from a first LIDAR in order to create a reference map, a plurality of second point cloud data acquired from a plurality of second LIDARs mounted on a vehicle traveling on a path on the reference map and specification values for the first LIDAR and the plurality of second LIDARs, a step of performing preprocessing on the first point cloud data and the plurality of second point cloud data and a step of performing calibration on the preprocessed first point cloud data and the plurality of second point cloud data.

According to still another embodiment of the present invention, the software 280a and 280b loaded in the memory 255 or stored in the storage 275 may be a computer program recorded on a recording medium which causes a processor 250 to execute a step of creating a first feature map based on an image captured from a camera and a step of creating a third feature map by mapping the first feature map to a second feature map created using pre-stored point cloud data.

More specifically, the processor 250 may include an application-specific integrated circuit (ASIC), other chipsets, logic circuits, and/or data processing devices. The memory 255 may include a read-only memory (ROM), a random access memory (RAM), a flash memory, a memory card, a storage medium, and/or other storage device. The transceiver 260 may include a baseband circuit for processing wired and wireless signals. The input/output device 265 may include input devices such as a keyboard, mouse and/or joystick, an image output device such as a liquid crystal display (LCD), an organic light emitting diode (OLED) and/or an active organic light emitting diode (Active Matrix OLED, AMOLED), and a printing device such as a printer and a plotter.

When the embodiments included in this specification are implemented as a software, the above-described method can be implemented as a module (process, function, etc.) that performs the above-described function. The module is loaded in memory 255 and can be executed by processor 250. Memory 255 can be internal or external to processor 250 and can be coupled to processor 250 by a variety of well-known means.

Each component shown in FIG. 3 can be implemented by various means, for example, hardware, firmware, software, or a combination thereof. In the case of implementation by hardware, an embodiment of the present invention can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

Also, in the case of implementation by firmware or software, an embodiment of the present invention can be implemented in the form of a module, procedure, function, etc. that performs the functions or operations described above, and can be recorded in a recording medium that can be read through various computer means. Here, the recording medium can include program instructions, data files, data structures, etc., singly or in combination. Program instructions recorded on the recording medium can be those specifically designed and constructed for the present invention, or can be known and available to those skilled in the art of computer software. For example, the recording media may include magnetic media such as hard disks, floppy disks and magnetic tapes, optical media such as a compact disk read only memory (CD-ROM) and a digital video disk (DVD), a magneto-optical media such as floptical disk, and hardware devices specially configured to store and execute program instructions such as ROM, RAM and flash memory. Examples of program instructions may include a machine language code such as that made by a compiler, as well as a high-level language code that can be executed by a computer using an interpreter, etc. Such hardware devices can be configured to operate as one or more software to perform the operations of the present invention, and vice versa.

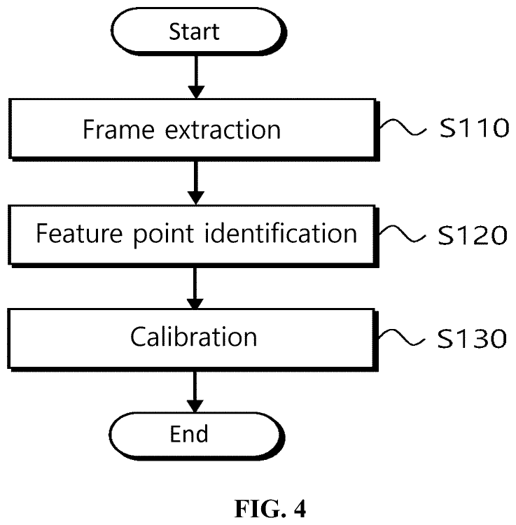

FIG. 4 shows a flowchart to explain a calibration method of a camera and a LIDAR according to an embodiment of the present invention.

Referring to FIG. 4, first, in step S110, the data creation device can extract one frame for each of the image captured by the camera and the point cloud data acquired by LIDAR. At this time, each frame for the extracted image and LIDAR can include a calibration board.

Next, in step S120, the data creation device can identify feature points on the calibration board included in one frame for each extracted image and LIDAR.

Here, the calibration board is a rectangular checker board, and can be formed of an edge identification region formed of a material with an intensity higher than a preset value and a top point identification region which is located at the top of the edge region and which is formed of a material with an intensity lower than a preset value.

Specifically, the data creation device can identify a corner based on the size and number of calibration boards in an image captured by a camera.

At this time, the data creation device can identify a point corresponding to a corner using a preset pattern on the basis of a feature point located at the top or bottom of the calibration board, and assign an index thereto.

Also, the data creation device can detect the calibration board from the point cloud data on the basis of the edge identification region with relatively high intensity on the calibration board, and identify a feature point within the detected calibration board.

Specifically, the data creation device can create a virtual plane based on the point cloud included in the edge identification region and create a plurality of straight lines by connecting the outermost points for each channel in the created virtual plane. Also, the data creation device can detect the vertex of the calibration board on the basis of the intersection of the plurality of created straight lines, and identify the feature point of the calibration board on the basis of the detected vertex.

That is, the data creation device can identify the four vertices included in the calibration board and identify the feature point of the calibration board based on the size and number of pre-stored calibration boards. Here, the feature point of the calibration board identified in the point cloud data can correspond to the feature point identified in the image.

Here, the data creation device can match the index of the feature point identified from the previously identified image to the feature point identified from the LIDAR based on the top point identification region of the calibration board.

And, in step S130, the data creation device can perform calibration on the camera and LIDAR based on the feature point identified from each of the image and point cloud data.

Specifically, the data creation device can calculate external parameters including rotation values and translation values based on the feature points of the calibration board included in each of the image and point cloud data, and perform calibration based on the calculated external parameters.

At this time, the data creation device can individually calculate the rotation value and translation value. Preferably, the data creation device can calculate the transformation value after calculating the rotation value.

First, the rotation value can be calculated through the following equation when defined as the rotation value from the first view point to the second view point.

$$\vert ( {f}_{1} * {Rf}_{1}^{′} ) ( {f}_{2} * {Rf}^{′} 2 ) ( {f}_{3} * {Rf}_{3}^{′} ) \vert = 0 \qquad Equation$$

wherein, R is the rotation value, and f, f′ are rays from the first view point and the second view point to the feature point of the calibration board included in the point cloud data.

The translation value can be calculated through a loss function based on a re-projection error (RPE). Here, the RPE may mean the degree to which a point observed in an image is distorted by being projected onto the image.

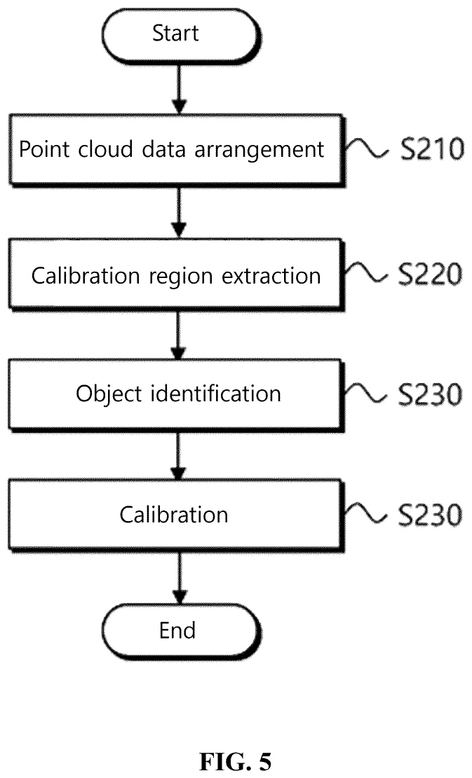

FIG. 5 is a flowchart for explaining a calibration method of LIDAR and inertial measurement device according to an embodiment of the present invention.

Referring to FIG. 5, first, in step S210, the data creation device can arrange the point cloud data acquired from a LIDAR mounted on a vehicle on a predefined world coordinate system.

At this time, the data creation device can define a world coordinate system using location information measured from at least one of a global positioning system (GPS) and an inertial measurement unit (IMU) acquired simultaneously with the point cloud data.

Next, in step S220, the data creation device can extract a region to be used for calibration from the arranged point cloud data.

Specifically, the data creation device can extract a trajectory in which the heading standard deviation that indicates the error in GPS data is lower than a preset value among the travel paths of the vehicle equipped with LIDAR, and extract a section that simultaneously contain trajectories in opposite directions of vehicle movement within the extracted trajectory.

Next, in step S230, the data creation device can identify at least one object included in the extracted region.

Specifically, the data creation device can identify a cylindrical object for horizontal fitting among the arranged point cloud data. For example, cylindrical object may include street lights, electric poles, traffic lights, etc.

Also, the data creation device can identify a ground for vertical fitting among the arranged point cloud data. At this time, the data creation device can extract a region of a preset size on the basis of the midpoint of the extracted section and recognize it as the ground.

Next, in step S230, the data creation device can perform calibration on the point cloud data by fitting the point cloud included in at least one identified object to a pre-stored model.

Specifically, the data creation device can calculate the value, which has been obtained by dividing the number of inlier points fitted to the pre-stored cylinder model corresponding to the cylindrical object by the number of point clouds included in the cylindrical object, as the loss for the cylindrical object

Also, the data creation device can calculate the value, which has been obtained by dividing the number of inlier point clouds fitted to the pre-stored ground model corresponding to the ground by the number of point clouds included in the ground, as the loss for the ground

The data creation device can perform calibration on point cloud data using a loss function configured based on the loss for the cylindrical object and the loss for the ground.

That is, the data creation device can configure a loss function as shown in the code below:

$$double loss = ( - 1 ) * pole\_loss + ( - 1 ) * ground\_loss$$

wherein pole_loss means the loss for the object, and ground_loss means the loss for the ground.

Here, assuming that the number of point clouds for the identified object is n and when the RANSAC algorithm is applied using a cylinder model, if the number of inliers in the fitted cylinder model is i, the loss for the object is calculated using the code below:

pole_loss=i/n

Also, assuming that the number of point clouds for the identified ground is n and when the RANSAC algorithm is applied using a ground model, if the number of inliers in the fitted ground model is i, the loss for the ground can be calculated using the code below:

ground_loss=i/n

Meanwhile, a horizontal fitting that considers both the x-axis and y-axis may cause a problem that produces an imbalanced loss, compared to a vertical fitting that considers only the z-axis. This imbalance in loss can make it difficult to converge to the correct answer because in the calibration process, a search is conducted near the local minimum rather than adjusting the ground and then moving to another location in a state that the loss has already dropped.

Accordingly, the data creation device can add a loss for the ratio between the loss for the cylindrical object and the loss for the ground to the loss function.

Meanwhile, the loss for the ratio between the loss for the cylindrical object and the loss for the ground can be calculated through the code below:

double ratio_loss;
if(pole_loss > ground_loss)
ratio_loss = ground_loss / pole_loss;
else // pole_loss < ground loss
ratio_loss = pole_loss / ground_loss;

Finally, the data creation device can construct a loss function as shown in the code below:

$$double lambda = 0.5 ;$$

$$double loss = ( - 1 ) * pole\_loss + ( - 1 ) * ground\_loss + ( - 1 ) * ratio\_loss * lambda ;$$

wherein, λ of 0.5 can solve the problem that the loss does not go down any further when the loss for the object and the loss for the ground have the same value.

And, in step S240, the data creation device can perform calibration on the point cloud data through particle swarm optimization (PSO) using the loss function.

Also, the data creation device can configure the loss function in a way of optimizing using the variance of the point cloud of the identified object.

Specifically, the data creation device configures at least one identified object into an octree, and uses the variance summation of each leaf node of the configured octree as a loss to calculate the point cloud data. Calibration can be performed.

At this time, the data creation device can configure a loss function by adding the length of the z-axis of the point cloud data to the variance weighted loss, and perform calibration on the point cloud data based on the loss function. Through this, the second calibration unit 220 can configure a loss function that is continuous for ground fitting and has had randomness removed.

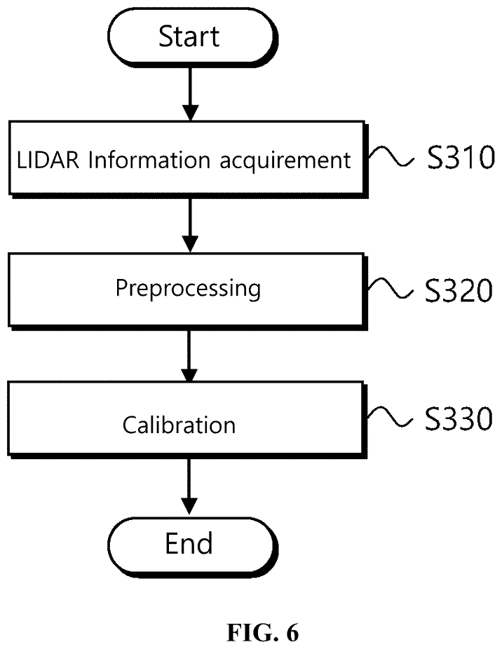

FIG. 6 is a flowchart for explaining a calibration method of a plurality of LIDARs according to an embodiment of the present invention.

Referring to FIG. 6, first, in step S310, the data creation device can acquire a first point cloud data acquired from a first LIDAR in order to create a reference map, a plurality of second point cloud data acquired from a plurality of second LIDARS mounted on a vehicle traveling on a path on the reference map, and specification values for one LIDAR and the plurality of second LIDARs.

Next, in step S320, the data creation device can perform preprocessing on the first point cloud data and the plurality of second point cloud data.

Specifically, the data creation device can voxelize the first point cloud data and the plurality of second point cloud data. Through this, the third calibration unit 225 can reduce the difference in the number of points between the first LIDAR and one of the plurality of second LIDARs and remove noise.

Also, the data creation device can perform preprocessing by defining outliers on the basis of distances between points in the first point cloud data and the plurality of second point cloud data.

Also, the data creation device can detect the ground from the plurality of second point cloud data and remove an object having a height of a preset value on the basis of the detected ground. In other words, the data creation device can perform preprocessing to delete objects such as vehicles and people on the basis of the height from the ground.

Also, the data creation device can detect the ground from the plurality of second point cloud data, approximate the point cloud detected as the ground to a plane, and then interpolate additional points between approximates the point cloud detected as the ground.

Next, in step S330, the data creation device can perform calibration on the preprocessed first point cloud data and plurality of second point cloud data.

Specifically, the data creation device can simultaneously perform calibration on the plurality of second LIDARs through multi-threading.

For calibration, the data creation device can perform a normal distribution transform (NDT) matching on each of the first point cloud data and the plurality of second point cloud data. At this time, the data creation device can perform calibration by designating the specification value of each of the plurality of second LIDARs as the initial pose.

In the process of NDT matching, the data creation device can determine the match between the first point cloud data and a plurality of second point cloud data using a fitness score, which is a sum of the errors in the average and covariance between voxels. At this time, the data creation device can extract the pose at the point of time when the fitness score becomes lower than the preset value. The data creation device can verify the calibration by comparing the fitness score at the point of time when the NDT matching is completed with a preset value.

Also, the data creation device can perform the NDT matching with the first point cloud data by designating a region of interest (ROI) to each of the plurality of second point cloud data. At this time, the data creation device can designate the region of interest to each of the plurality of second point cloud data on the basis of the coordinate system of the first point cloud data, wherein the region of interest can be designated after aligning the coordinate system of the first point cloud data and the second point cloud data using the specification value of each of the plurality of second LIDARs. The data creation device can determine the match between the first point cloud data and the plurality of second point cloud data using the fitness score of the designated region of interest. At this time, the data creation device can extract the pose at the point of time when the fitness score becomes minimum.

Here, the data creation device can extract the pose at point of time when the fitness score becomes minimum by performing NDT matching while changing the yaw value of each of the plurality of second point cloud data to a preset angle, and re-input the extracted pose as the initial pose of the NDT matching.

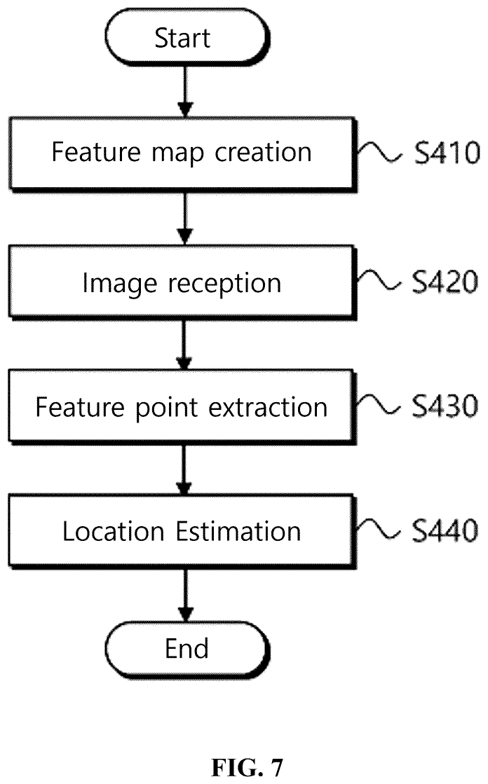

FIG. 7 is a flowchart for explaining a visual mapping method according to an embodiment of the present invention.

Referring to FIG. 7, first, in step S410, the data creation device can create a feature map by mapping the feature point of an image captured by a camera to a point cloud data acquired by LIDAR.

To this end, the data creation device can create a first feature map based on the point cloud data acquired by the LIDAR and image captured by the camera.

Specifically, the data creation device can acquire the point cloud data and image through the LIDAR mounted on a vehicle and acquiring point cloud data and a camera installed at the same location as the LIDAR.

The data creation device can extract a feature point from the acquired image and create a first feature map configured with the extracted feature point. Here, the data creation device can extract the feature point from each pixel included in the image based on the continuity of brightness for pixels that exist within a preset range.

That is, if there are n or more consecutive pixels that are brighter than a certain value or n or more consecutive pixels that are darker than a certain value, compared to the specific pixel included in the image, the data creation device can determine the specific pixel to be a corner point.

To this end, the data creation device can classify the brightness value of a pixel into three values: a case that it is much darker than a specific pixel and a case that it is similar to the specific pixel, and express the brightness distribution of pixels on the circumference as a ternary vector of sixteen dimensions using the classified values. The data creation device can classify whether there is a corner point or not by inputting the expressed ternary vector into the decision tree.

Also, the data creation device can gradually reduce the image to a preset scale and apply a blurring thereto, extract the outline and corner included in the image through the difference of Gaussian (DoG) function, extract pixels of the maximum and minimum values for each pixel in the image composed of the extracted outline and corner and extract pixels having the extracted maximum and minimum values as the feature point.

Also, the data creation device can set a window centered on each pixel included in the image and detect a corner by moving the set window by a predetermined direction and distance.

As a result, the data creation device can create a feature map based on feature point located at the detected corner among feature points extracted based on the continuity of brightness. That is, the map creation unit 230 can create a first feature map composed only of feature point extracted from the image.

Next, the data creation device can create a third feature map by mapping the first feature map to the second feature map created using pre-stored point cloud data.

Specifically, the data creation device can map the first feature map to the second feature map based on the location information and pose information of the point cloud data acquired simultaneously with the image for creating the first feature map.

Meanwhile, the second feature map can be a point cloud map created using an equipment, which acquires the image and point cloud data, for creating the first feature map and point cloud data acquired by the same equipment.

Accordingly, the data creation device can omit the pose optimization process when mapping the first feature map to the second feature map. Due to this, the map creation unit 230 can not only create a lightweight feature map created from only the feature point, but also create a third feature map at high speed.

Next, in step S420, the data creation device can create a third feature map and then receive in real time at least one image for location estimation.

Next, in step S430, the data creation device can analyze at least one received image in real time to extract the feature point. Here, the map creation unit 230 can extract the feature point from the image in the same manner as the method of extracting feature point to create the first feature map described above.

And, in step S440, the data creation device can estimate the location on the image received in real time by matching the extracted feature point with the third feature map. At this time, the map creation unit 230 can estimate the pose of the camera of the data collection device based on information about the feature point of at least one image received in real time and the feature point of the third feature map. At this time, the data creation device can estimate the pose of the camera of the data collection device based on information about the feature point of at least one image received in real time and the feature point of the third feature map.

Also, when the data creation device fails to estimate the location of a first image among at least one images, the map creation unit 230 can estimate the location of the first image based on the pose of the second image that is an image for which location estimation was previously successful. In other words, the data creation device can predict the location of the image that failed to estimate the location based on the location and pose of the previously captured image.

Meanwhile, at least one images received in real time can be an image captured by a terminal equipped with a camera and an inertial measurement device.

At this time, the data creation device can estimate the location of the first image by reflecting the pose measured by the inertial measurement device on the basis of the pose of the second image, to thereby increase the accuracy of location and pose estimation of the image for which location estimation was failed.

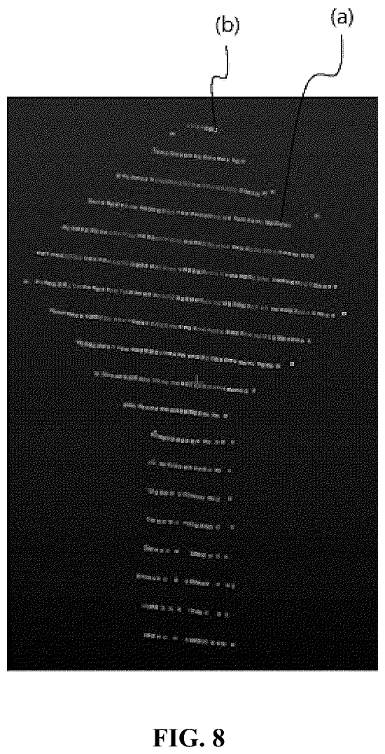

FIGS. 8 to 11 are exemplary diagrams for explaining a calibration method of a camera and a LIDAR according to an embodiment of the present invention.

As shown in FIG. 8, a calibration board can be formed with an edge identification region (a) of which edge is made of a material with a higher intensity than a preset value and a top point identification region (b) located at the top of the edge identification region (a) and made of a material with lower intensity than a preset value.

For example, the calibration board can have a high-brightness tape made of a material with an intensity higher than a preset value attached along the edge of a checker board to form the edge identification region (a). At this time, a portion of the high-brightness tape located at the top of the calibration board can be removed to form the top point identification region (b).

Meanwhile, the points outside the calibration board included in the point cloud data all exist within one plane, but in reality, due to the noise of the LIDAR, they cannot exist exactly within one plane.

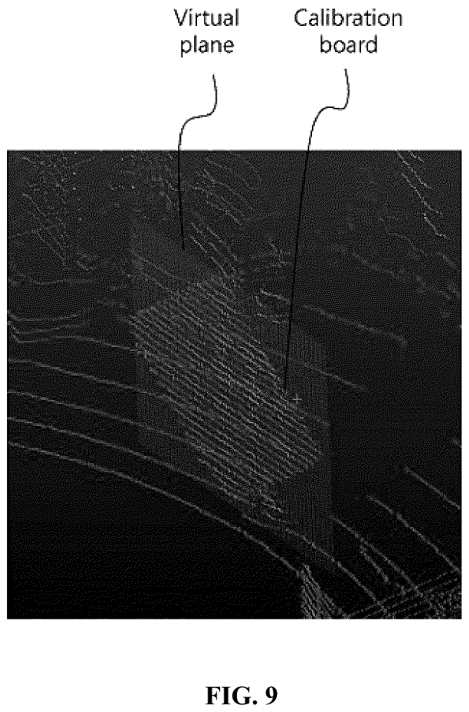

Accordingly, as shown in FIG. 9, the data creation device can create a virtual plane on the basis of the point cloud included in the edge identification region in order to extract feature points from the point cloud data acquired from a LIDAR.

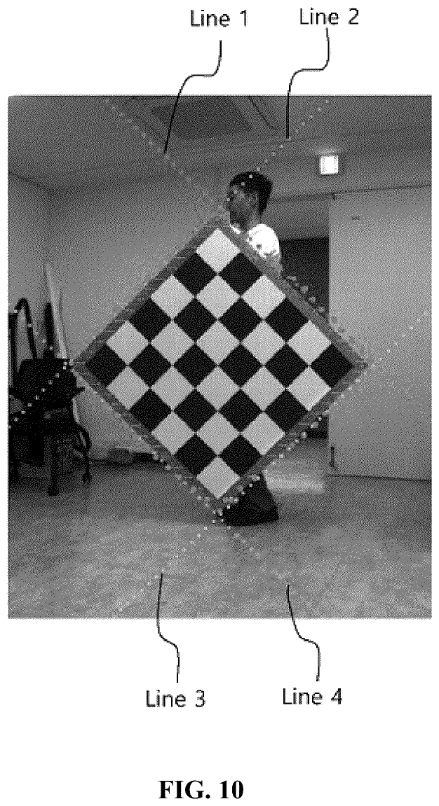

Thereafter, as shown in FIG. 10, the data creation device can create a plurality of straight lines by connecting the outermost points for each channel on the created virtual surface. In other words, the data creation device can acquire four straight lines (line 1, line 2, line 3, and line 4) by connecting the outermost points for each channel of the LIDAR.

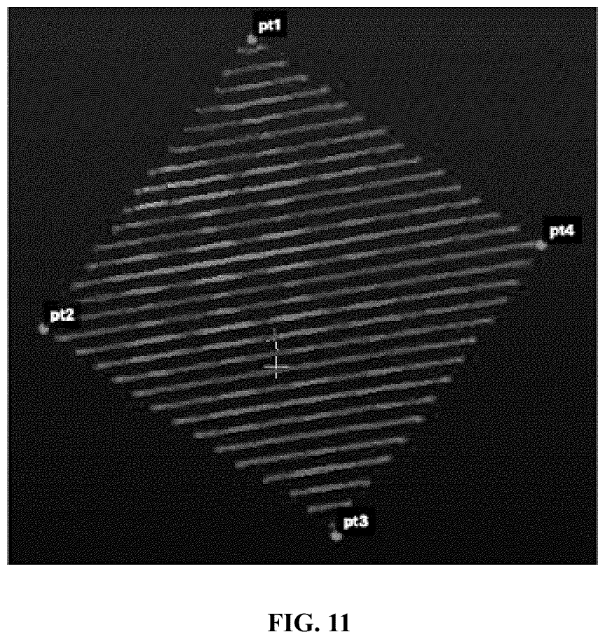

And, as shown in FIG. 11, the data creation device can detect the vertices (pt1, pt2, pt3, and pt4) of the calibration board on the basis of the intersection of the plurality of created straight lines, and identify the feature points of the calibration board on the basis of the detected vertices.

That is, the data creation device can identify the four vertices included in the calibration board and identify the feature points of the calibration board based on the size and number of pre-stored calibration boards.

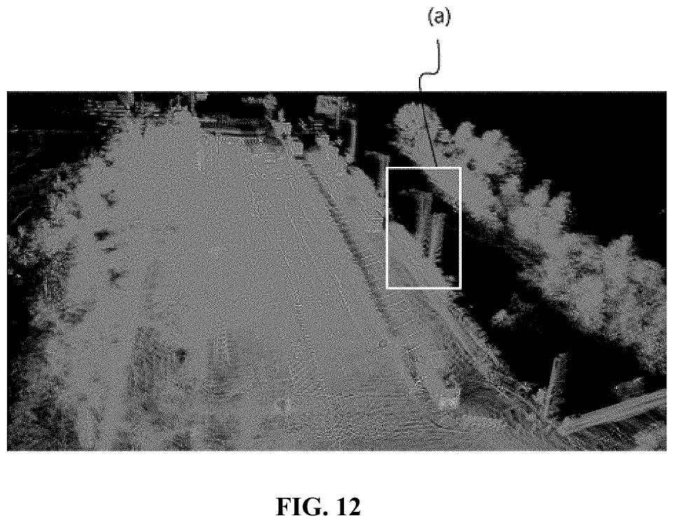

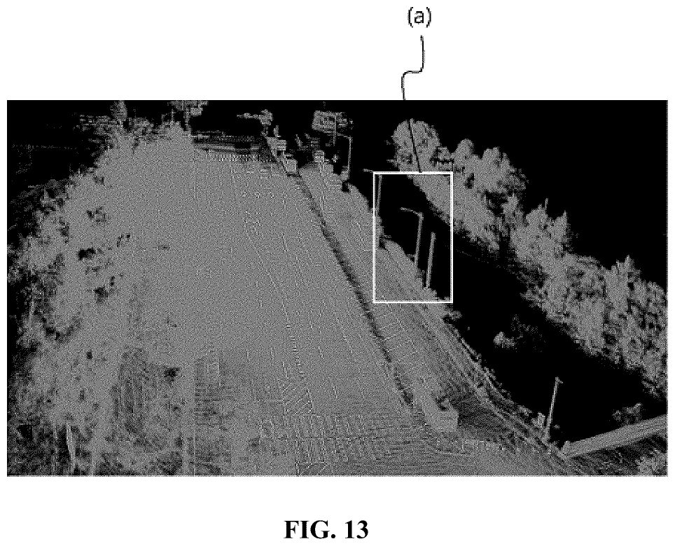

FIGS. 12 and 13 are flowcharts for explaining a calibration method of a LIDAR and an inertial measurement device according to an embodiment of the present invention.

Generally, calibration between LIDAR and inertial measurement device is performed manually by a worker using specific tools.

At this time, in the case of LIDAR and camera, the LIDAR is overlaid on a two-dimensional image, and thus the worker can intuitively check in which direction the LIDAR points move when changing the rotation value.

In contrast, in the case of LIDAR and inertial measurement device, the results must be confirmed in three dimensions, and thus, for manual work, the only way was to change, enlarge and check the direction of the map. Also, when changing the rotation value, it is not easy to recognize how the map will be changed using the changed rotation value.

Also, in the case of LIDAR and inertial measurement device, as shown in FIG. 12(a), there exist sections with noticeable errors and resultantly correct answer cannot be given and the worker must determine the degree of calibration.

Accordingly, the data creation device can perform calibration on the LIDAR and the inertial measurement device using the features according to the shape of a specific object included in the point cloud data acquired by the LIDAR, as shown in FIG. 13(a).

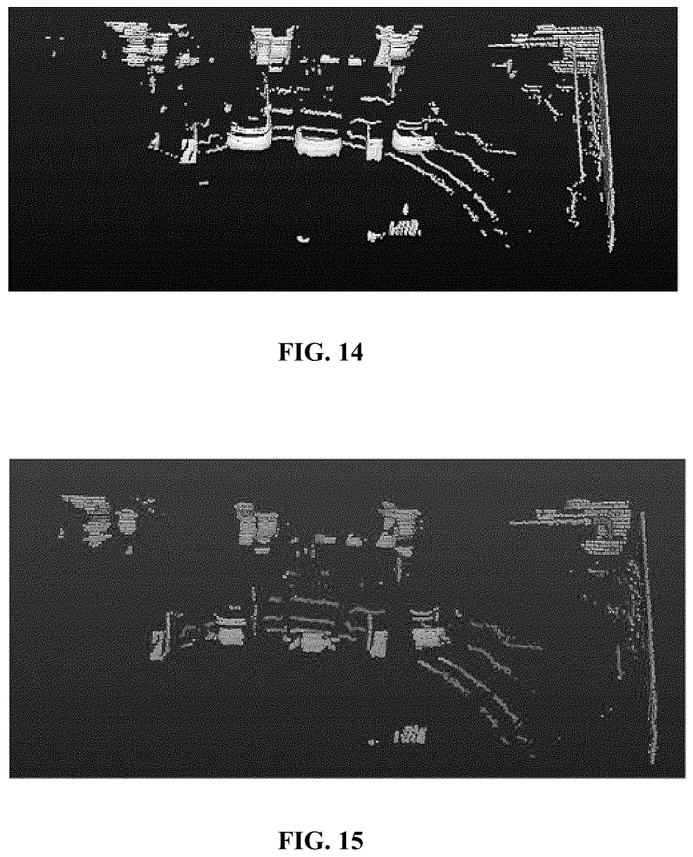

FIGS. 14 and 15 are exemplary diagrams for explaining a calibration method of a plurality of LIDARs according to an embodiment of the present invention.

Meanwhile, FIG. 14 is a diagram showing the second point cloud data before preprocessing, and FIG. 15 is a diagram showing the second point cloud data after preprocessing.

Referring to FIGS. 14 and 15, because calibration is performed between the LIDAR for creating the reference map and the LIDAR mounted on the vehicle, point clouds corresponding to vehicles or people that do not exist on the reference map may cause calibration errors.

Accordingly, the data creation device can detect the ground from the plurality of second point cloud data and remove an object having a height of a preset value on the basis of the detected ground. That is, the second point cloud data can be preprocessed to identify and delete objects such as vehicles and people on the basis of their height from the ground.

Also, the fitness score used for NDT matching may mean an average distance of points whose distance is less than a certain value after having each one point of the plurality of second point cloud data matched with the closest point in the first point group data, the average of the distances of the points whose distance is less than a certain value can refer to the average distance of points whose distance is less than a certain value after each one point of the plurality of second point cloud data is matched with the closest point in the first point cloud data. Accordingly, in order to reduce the error in the z-axis values of the plurality of second LIDARs, the specific gravity of the ground must be as large as the walls and pillars.

Accordingly, the data creation device can detect the ground from a plurality of second point cloud data, approximate the point cloud detected as the ground to a plane and then interpolate additional points between the point clouds detected as the ground.

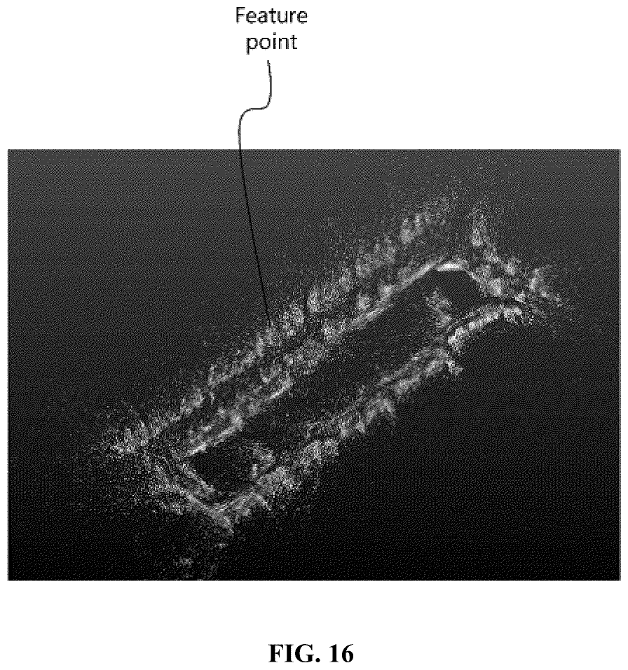

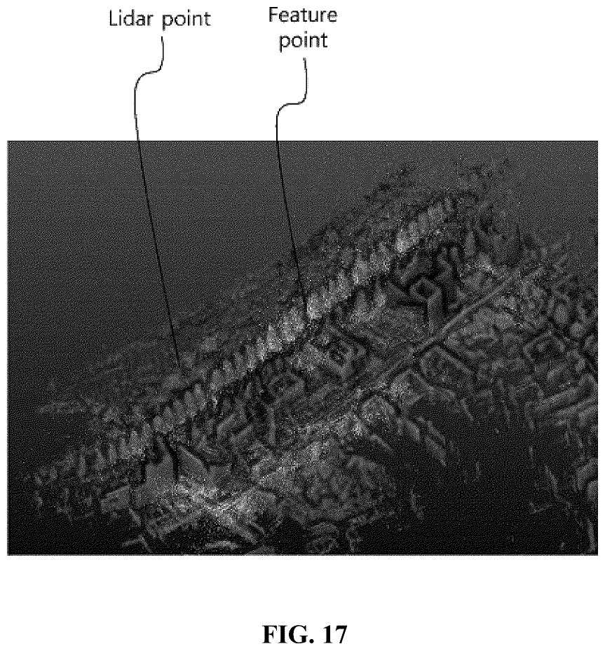

FIGS. 16 and 17 are exemplary diagrams for explaining a visual mapping method according to an embodiment of the present invention.

Meanwhile, FIG. 16 is a diagram showing a first feature map, and FIG. 17 is a diagram showing a third feature map created by mapping the first feature map to the second feature map.

As shown in FIG. 16, the data creation device can create a feature point map based on a feature point located at a detected corner among feature points extracted based on the continuity of brightness. In other words, the data creation device can create a first feature map composed only of feature point extracted from the image.

Next, the data creation device can create a third feature map by mapping the first feature map to the second feature map created through pre-stored point cloud data (LIDAR point), as shown in FIG. 17.

Specifically, the data creation device can map the first feature map to the second feature map based on the location information and pose information of the point cloud data acquired simultaneously with the image for creating the first feature map.

As described above, preferred embodiments of the present invention have been disclosed in the specification and drawings, but it is evident to those with ordinary knowledge in the field that other modifications based on the technical idea of the present invention can be implemented in addition to the embodiments disclosed herein. Also, although specific terms are used in the specification and drawings, they are merely used in a general sense to easily explain the technical content of the present invention and aid understanding of the invention, and are not intended to limit the scope of the present invention. Accordingly, the above detailed description should not be construed as restrictive in all respects and should be considered illustrative. The scope of the present invention must be determined by reasonable interpretation of the appended claims, and all changes within the equivalent scope of the present invention are included in the scope of the present invention.

1. A calibration method comprising the steps of:
acquiring, by a data creation device, first point cloud data from a first LIDAR in order to create a reference map, a plurality of second point cloud data acquired from a plurality of second LIDARs mounted on a vehicle traveling on a path on the reference map and specification values for the first LIDAR and the plurality of second LIDARs;
performing, by the data creation device, preprocessing on the first point cloud data and the plurality of second point cloud data; and
performing, by the data creation device, calibration on the preprocessed first point cloud data and plurality of second point cloud data.

2. The calibration method according to claim 1, wherein the step of performing the preprocessing includes voxelizing the first point cloud data and the plurality of second point cloud data.

3. The calibration method according to claim 1, wherein the step of performing the preprocessing includes detecting the ground from the plurality of second point cloud data, and identifying and removing an object having a height of a preset value on the basis of the detected ground as a noise object.

4. The calibration method according to claim 1, wherein
the step of performing the preprocessing includes detecting the ground from the plurality of second point cloud data, approximating the point cloud detected as the ground to a plane, and then interpolating additional points between the point clouds detected as the ground.

5. The calibration method according to claim 1, wherein the step of performing the calibration includes performing a normal distribution transform (NDT) matching on each of the first point cloud data and the plurality of second point cloud data, and simultaneously performing calibration on the plurality of second LIDARs through multi-threading.

6. The calibration method according to claim 5, wherein the step of performing the calibration includes performing the calibration by designating the specification value of each of the first LIDAR and the plurality of second LIDARs as initial pose.

7. The calibration method according to claim 6, wherein the step of performing the calibration includes determining a matching between the first point cloud data and the plurality of second point cloud data using a fitness score that is a sum of average and covariance between voxels during the NDT matching process.

8. The calibration method according to claim 4, wherein the step of performing the calibration includes performing a NDT matching with the first point cloud data by designating a region of interest (ROI) to each of the plurality of second point cloud data.

9. The calibration method according to claim 8, wherein the step of performing the calibration includes designating the region of interest to each of the plurality of second point cloud data on the basis of the coordinate system of the first point cloud data, and wherein the region of interest is designated after aligning the coordinate system of the first point cloud data and the plurality of second LIDARs using specification value of each of the plurality of second LIDARs.

10. A computer program recorded on a recording medium being combined with a computing device including a memory, a transceiver and a processor for processing instructions loaded in the memory, wherein the computer program causes the processor to execute the steps of:
acquiring first point cloud data from a first LIDAR in order to create a reference map, a plurality of second point cloud data acquired from a plurality of second LIDARs mounted on a vehicle traveling on a path on the reference map and specification values for the first LIDAR and the plurality of second LIDARs;
performing preprocessing on the first point cloud data and the plurality of second point cloud data; and
performing calibration on the preprocessed first point cloud data and plurality of second point cloud data.
